(19) United States
(12) Patent Application Publication
(10) Pub. No.: US 2024/0311735 A1
(43) Pub. Date: Sep. 19, 2024

(54) Multivariate Skill Demand Forecasting System

(71) Applicant: International Business Machines Corporation, Armonk, NY (US)

(72) Inventors: Maysa Malfiza Garcia de Macedo, São Paulo (BR); Wyatt Gabriel Clarke, Yonkers, NY (US); Tyler Baldwin, Culver City, CA (US); Dilermando Queiroz Neto, São Paulo (BR); Rogerio Abreu de Paula, São Paulo (BR); Subhro Das, Cambridge, MA (US)

(21) Appl. No.: 18/183,248

(22) Filed: Mar. 14, 2023

(51) Int. Cl. G06Q 10/0639; G06Q 10/04

(52) U.S. Cl. CPC G06Q 10/0639; G06Q 10/04

(57) ABSTRACT

A computer implemented method determines skill shares for skills from job advertisements. A skill share for a skill identifies a number of times a skill has appeared in job advertisements during a given period of time. The computer implemented method creates a time series of skill demand using the skill shares. The computer implemented method extracts embeddings from job advertisements for an occupation using natural language processing. The computer implemented method clusters the skills using the embeddings to form skill clusters. The computer implemented method defines a training dataset using as a time series of skill demand for all skills within a cluster containing a selected skill to be predicted. The computer implemented method trains a time series prediction model using the training dataset.

### BACKGROUND

The disclosure relates generally to an improved computer system and more specifically to a method, apparatus, system, and computer program product for forecasting multivariate skill demands.

Emerging technologies and market forces have caused workplace changes that occur at increasing frequency and speed. These workplace changes include changes in jobs and skills needed for jobs. Companies have a desired set of skills to perform a particular job successfully. This list of skills changes in response to emerging technologies and market forces. As result, an employee can have a skill gap. This skill gap is a difference between the current abilities of the employee in the skill set best suited for their job.

With technological changes, the skill set needed for a particular job can change rapidly. As a result, many in the workforce may be unprepared to perform their jobs or obtain new jobs because of skill set changes. As result, employees may perform research and analysis to determine whether their skill set will be in demand in the future. Further, employees may also perform research and analysis to determine what skills they may want to acquire for their job for another similar job.

### SUMMARY

According to one illustrative embodiment, a computer implemented method is provided. A number of processor units determines skill shares for skills from job advertisements. A skill share for a skill identifies a number of times a skill has appeared in job advertisements during a given period of time. The number of processor units creates a time series of skill demand using the skill shares. The number of processor units extracts embeddings from job advertisements for an occupation using natural language processing. The number of processor units clusters the skills using the embeddings to form skill clusters. The number of processor units defines a training dataset using as a time series of skill demand for all skills within a cluster containing a selected skill to be predicted. The number of processor units trains a time series prediction model using the training dataset. According to other illustrative embodiments, a computer system and a computer program product for predicting skill demand are provided.

### BRIEF DESCRIPTION OF THE DRAWINGS

FIG. 1 is a block diagram of a computing environment in accordance with an illustrative embodiment;

FIG. 2 is a block diagram of a skill analysis environment in accordance with an illustrative embodiment;

FIG. 3 is a dataflow diagram for analyzing skill data in accordance with an illustrative embodiment;

FIG. 4 is a data flow diagram illustrating generating a report of trends for user in accordance with an illustrative embodiment;

FIG. 5 is a data flow diagram illustrating an example use case for generating a report of trends for a user in accordance with an illustrative embodiment;

FIG. 6 is a flowchart of a process for analyzing skills in accordance with an illustrative embodiment;

FIG. 7 is a flowchart of a process for determining a skill demand in accordance with an illustrative embodiment;

FIG. 8 is a flowchart of process for receiving user input in accordance with an illustrative embodiment;

FIG. 9 is a flowchart of a process for creating embeddings in accordance with an illustrative embodiment;

FIG. 10 is a flowchart of a process for creating a training data set in accordance with an illustrative embodiment; and

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

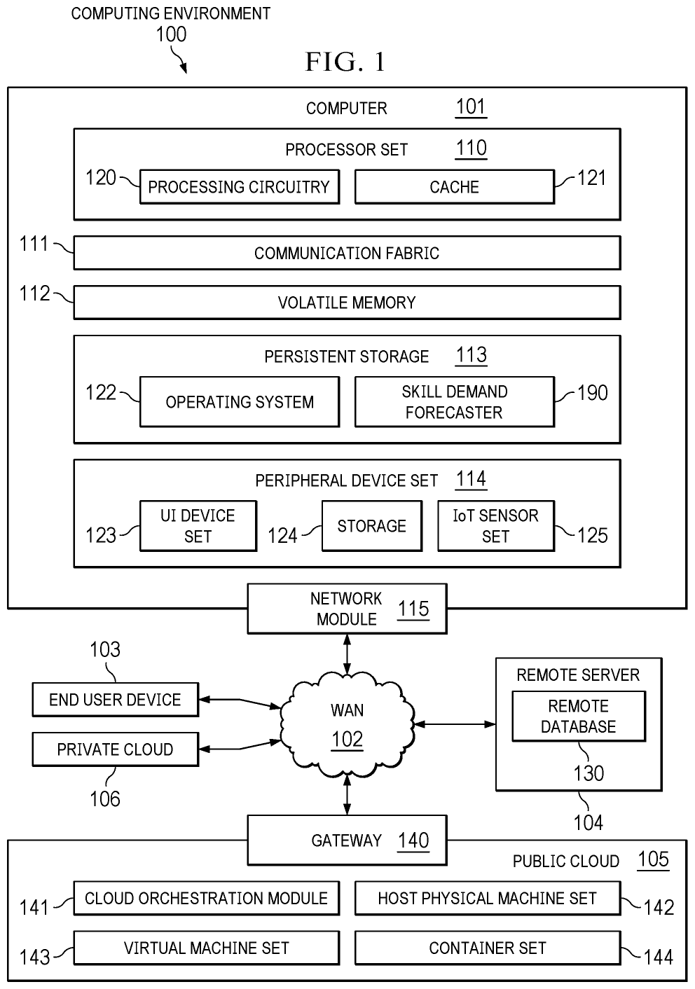

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as skill demand forecaster 190. In addition to skill demand forecaster 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and skill demand forecaster 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in skill demand forecaster 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in skill demand forecaster 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number considerations as described herein. For example, it is beneficial for companies to enable their employees to understand the future demand for their skills and be able to acquire new skills or update current skills as the skill set for jobs change. Accurate forecasting of future demand for skills can enable employees to understand the future demand for the skills. Further, the employees can also learn about skills that may become more important in the future. As result, employees can update or acquire new skills to ensure successful performance of their jobs.

An ability to forecast skills for employees, students, and other users can enable users to have a fuller and quicker understanding of the demand for their skills in a future period of time such as six months, one year, or three years. This kind of skill assessment can help users perform decision-making with respect to their skills. Forecasting a demand for skills can be technically challenging to identify data and analysis processes for more accurate forecasts. Current forecasting techniques are not as accurate as desired to forecast individualized assessments for skills.

Thus, the illustrative embodiments provide a computer implemented method, apparatus, computer system, and computer program product for forecasting a future demand for skills. In one illustrative example, a number of processor units determines skill shares for skills from job advertisements. A skill share for a skill is a metric that identifies a number of times a skill has appeared in job advertisements during a given period of time. The number of processor units creates a time series of skill demand using the skill shares. The computer implemented method extracts embeddings from data sources such as job advertisements for an occupation using natural language processing. The number of processor units clusters the skills using the embeddings to form skill clusters. The number of processor units defines a training dataset using a time series of skill demand for all skills within a cluster containing a selected skill to be predicted. The number of processor units trains a time series prediction model using the training dataset. In the illustrative examples, this model can be a multivariate time series prediction model. According to other illustrative embodiments, a computer system and a computer program product for predicting skill demand are provided.

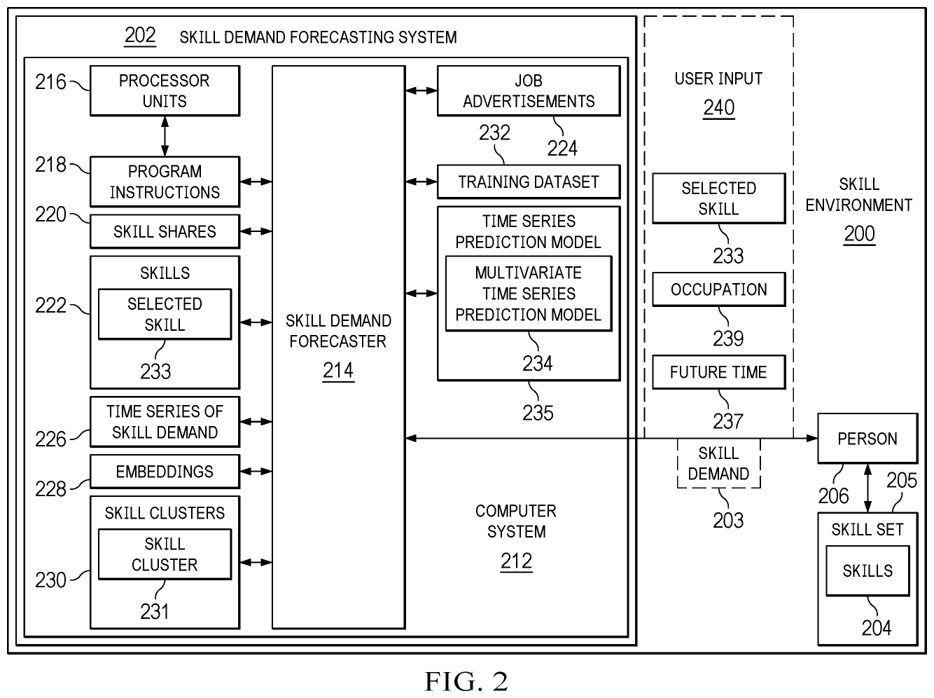

With reference now to FIG. 2, a block diagram of a skill analysis environment is depicted in accordance with an illustrative embodiment. In this illustrative example, skill environment 200 includes components that can be implemented in hardware such as the hardware shown in computing environment 100 in FIG. 1.

In this illustrative example, skill demand forecasting system 202 can determine a skill demand 203 for a set of skills 204 in skill set 205 for person 206 at future time 237. In this example, skill demand forecasting system 202 comprises computer system 212 and skill demand forecaster 214.

Skill demand forecaster 214 can be implemented in software, hardware, firmware or a combination thereof. When software is used, the operations performed by skill demand forecaster 214 can be implemented in program instructions configured to run on hardware, such as a processor unit. When firmware is used, the operations performed by skill demand forecaster 214 can be implemented in program instructions and data and stored in persistent memory to run on a processor unit. When hardware is employed, the hardware can include circuits that operate to perform the operations in skill demand forecaster 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program instructions that operate a computer. A processor unit can be implemented using processor set 110 in FIG. 1. When the number of processor units 216 executes program instructions 218 for a process, the number of processor units 216 can be one or more processor units that are on the same computer or on different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, skill demand forecaster 214 determines skill shares 220 for skills 222 from job advertisements 224. A job advertisement is an announcement of a particular position for the company or other organization. This advertisement can be posted through various platforms including websites, internal intranets, or other platforms to encourage people to apply for that particular position. A job advertisement can include an identification of the occupation. The advertisement can also include desired or required items such as skills, experience, educational level, and other items. A job advertisement can also be referred to as a job posting. These job advertisements are a source of data for use in determining skill demand 203 for skills 204 in skill set 205 for person 206.

In this illustrative example, skills 222 identified from job advertisements 224. A skill share for a skill is a metric and identifies a number of times the skill has appeared in job advertisements 224 during a given period of time.

Skill demand forecaster 214 creates time series of skill demand 226 using skill shares 220. In this example, time series of skill demand 226 is created for all of skills 222 identified from the data in job advertisements 224.

Additionally, skill demand forecaster 214 can extract embeddings 228 from job advertisements 224 for an occupation using natural language processing. In this illustrative example, an embedding is an information dense representation of a semantic meaning for text. In this example, this representation is for text in job advertisements 224. In this illustrative example, these embeddings can be represented using a vector of floating-point numbers. The distance between two embeddings in the vector spaces correlate to semantic meaning between the two inputs in the original format.

In this illustrative example, skill demand forecaster 214 clusters skills 222 using embeddings 228 to form skill clusters 230. Skill demand forecaster 214 defines training dataset 232 using as time series of skill demand 226 for all skills in skill cluster 231 in skill clusters 230 containing selected skill 233 in skills 222 to be predicted.

Skill demand forecaster 214 trains time series prediction model 235 using training dataset 232. In this example, time series prediction model 235. A machine learning model is a type of artificial intelligence model that can learn without being explicitly programmed. A machine learning model can learn based training data input into the machine learning model. The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms. Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

In this illustrative example, the type of machine learning model used is time series prediction model 235. Time series prediction model 235 can predict multiple variables for different time steps in a time series. In this example, the variables are skills. In this example, the values predicted for the skills are skill shares which can be predicted over different time steps. In this example, the particular type of time series prediction model can be multivariate time series prediction model 234, which is a type of machine learning model. This type of machine learning model can analyze several time series jointly. In this manner, interdependencies between different time series for different skill in a skill cluster can be considered.

With training, multivariate time series prediction model 234 can predict skill share 236 for all skills in skill cluster 231 in skill clusters 230 for the future time using the multivariate time series prediction model. In other words, this type of machine learning model can consider multiple time series or multiple skills. This skill share can be used to determine skill demand for selected skill 233 at a future time 237. For example, skill demand forecaster 214 can determine skill demand 203 for selected skill 233 in skill cluster 231 for future time 237 using the skill share the predicted for selected skill 233.

In this example, the future time can be measured as time steps. For example, a time step can be one month, three months, six months, or some other time step in the future. Time steps for the future time can also take other forms such as weeks, quarters, or some other time step.

In this illustrative example, the prediction of skill shares can be in response to user input 240. In this illustrative example, user input 240 is received from person 206. In this example, the user input can include selected skill 233, occupation 239, and future time 237. In response, skill demand forecaster 214 can determine skill demand 203 for person 206. With skill demand 203, person 206 can more effectively evaluate skill set 205. For example, person 206 may determine to improve the depth or increased expertise for selected skill 233. In other illustrative examples, selected skill 233 may be a skill that person 206 does not have in skill set 205. In this case, person 206 can determine whether skill demand 203 for selected skill 233 in the future warrants the gain of demand.

In one illustrative example, one or more solutions are present that overcome a problem with predicting the demand for skills for user for a user at a future point in time. As a result, one or more solutions for predicting demand for user skills through predicting skill shares. In the different illustrative examples, the skill share for skill can be used to determine a skills score. Skill score is the sum of skill share of each skill of person 206.

Computer system 212 can be configured to perform at least one of the steps, operations, or actions described in the different illustrative examples using software, hardware, firmware or a combination thereof. As a result, computer system 212 operates as a special purpose computer system in which skill demand forecaster 214 in computer system 212 enables predicting a skill score that indicates a future demand for a skill through analyzing job advertisements and employment data. This analysis can be performed for a skill by clustering other skills based on the how similar skills are to each other. This clustering can be used to identify skills with high similarity for a joint prediction. Time series of skill demand data can identify for those skills and used to train a machine learning model. This machine learning model can be used to predict the skill demand for that skill. In particular, skill demand forecaster 214 transforms computer system 212 into a special purpose computer system as compared to currently available general computer systems that do not have skill demand forecaster 214.

In the illustrative example, the use of skill demand forecaster 214 in computer system 212 integrates processes into a practical application for method for analyzing skills to predict a trend of skills in a future time. In other words, skill demand forecaster 214 in computer system 212 is directed to a practical application of processes integrated into skill analysis to determine data in the form of skill demand 203.

The illustration of skill environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, the illustrative example has been described with respect to predicting the skill demand 203 for a single skill. In another illustrative example, person 206 can submit multiple skills in user input 240. For example, person 206 can submit all of skills 204 in skill set 205. In another illustrative example, person 206 can submit a skill of interest as selected skill 233. The skill of interest may be a skill that person 206 is person 206 does not have but is considering learning to add to skill set 205. In another example, other types of time series prediction machine learning models can be used.

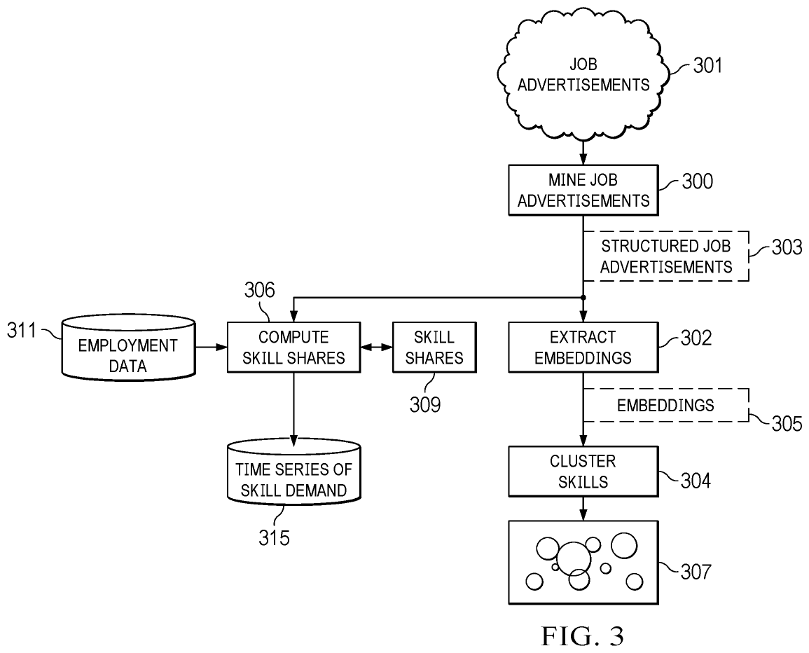

With reference next to FIG. 3, a dataflow diagram for analyzing skill data is depicted in accordance with an illustrative embodiment. The data flow in this illustrative example includes steps and processes that can be implemented in skill demand forecaster 214 in FIG. 2. In this example, the different steps can be used to analyze skill data from different sources and generate time series of skill demand 315 and skill clusters 307.

As depicted, job advertisements 301 are located online in a location such as the cloud. Job advertisements 301 are mined from the cloud (step 300). In this example, job advertisements 301 are sources of data regarding skills and can be advertisements or postings obtained from job websites, professional media platforms, social media platforms, job posting sites, or other online platforms. These online advertisements are examples of job advertisements 224 in FIG. 2.

As part of the mining process, the data in job advertisements 301 can be processed. The processing can include structuring the data in job advertisements 301. For example, metadata can be used to identify data such as occupation, skills required, education level required, and text of a job advertisement. In this example, this processing results in structured job advertisements 303.

In this illustrative example, embeddings 305 are extracted from text and structured job advertisements 303 (step 302). In step 302, this extraction can be performed using a natural language processing algorithm. Example of a natural processing language algorithm that can be used is Word2vec. The extraction produces a space of n-embeddings for each job advertisement that is processed.

The process clusters skills using embedding 305 (step 304). The clustering performed in step 304 forms skill clusters 307.

In this example, the process computes skill shares 309 (step 306). In step 306, structured job advertisements 303 and employment data 311 are used to compute skill shares 309. In this example, the employment data provides information about the number of hired employees per occupation per month. Further, the employment data can also indicate the total number of employees employed per month.

A skill share in skill shares 309 can be determined as is as follows:

$$skill {share}_{i , j , t} = \frac{{ads}_{i , j , t}}{all {ads}_{j , t}} \times \frac{{emp}_{j , t}}{all {emp}_{t}} \qquad ( 1 )$$

where i is a skill, j is an occupation, and t is a month, ads i,j,t is the number of advertisements for skill i in occupation j in month t, and all ads j,t is the number of advertisements for occupation j in month t, emp j,t is employment for occupation j in month t, and all emp,t is employment for all occupations in month t. The information for ads i,j,t and all ads j,t is extracted from structured job advertisements 303.

In this illustrative example, a skill share is a metric that identifies the number of times that a skill for an occupation has appeared in job advertisements for an occupation during a given month multiplied by the number of workers employed in the occupation divided by all employees in all occupations. The second term in equation (1) provides for normalization across a labor market.

The skill shares for different periods of time are stored as time series of skill demand 315. In other words, the skill shares over time are stored as time series data that indicate a skill demand. In other words, skill shares in time series of skill demand 315 can be stored in association with timestamps that indicate when particular skill shares were present.

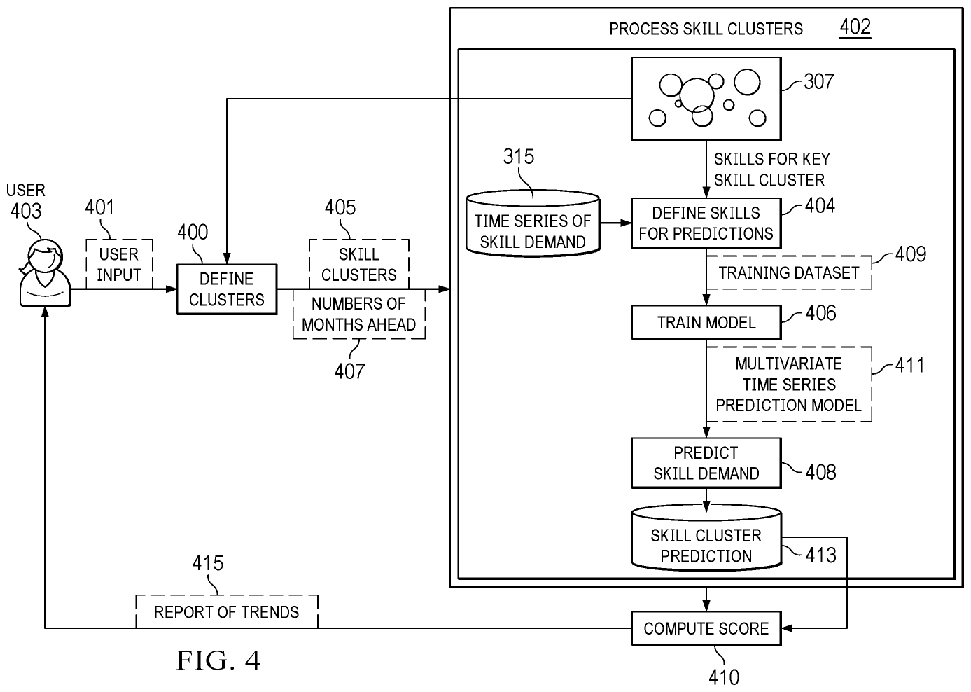

Turning to FIG. 4, a data flow diagram illustrating generating a report of trends for a user is depicted in accordance with an illustrative embodiment. In the illustrative examples, the same reference numeral may be used in more than one figure. This reuse of a reference numeral in different figures represents the same element in the different figures. In this example, the process uses time series of skill demand 315 and skill clusters 307 that were determined in the dataflow in FIG. 3.

In this example, the process defines clusters (step 400) based on user input 401 received from user 403. In this example, user input 401 includes information about the user. The information in this example includes skills, occupation, and a future time. In this example, future time is a number of months. The number of months ahead can be any number of months ahead. For example, the number of months ahead can be 3 months, 6 months, 7 months, or some other number of months in the future.

With the identification of the occupation and the skills for the user, the process in step 400 identifies one or more of the clusters in skill clusters 307 based on the skills for user 403. In this example, the process determines which skill clusters in skill clusters 307 contain the skills for the user in user input 401. In this example, the identification of skills is also with respect to an occupation. For example, a skill Python for a university occupation can have a different skill cluster from the skill Python for a commercial occupation.

The process analyzes skill clusters 405 based on the number of months ahead 407 (step 402). The different steps depicted for processing skill clusters in step 402 are performed for each of the skill clusters in skill clusters 405. In other words, in step 402, the process manages multivariate prediction for each skill cluster in skill clusters 405 to number of months ahead 407. In this example, the skill selected for processing is a key skill and the skill cluster having that key skill identified for processing is a key skill cluster.

As depicted, the process defines skills for prediction for a key skill cluster (step 404). In defining the skills for prediction in step 404, the process identifies all of the skills for the key skill cluster in skill clusters 307. The process in step 404 also collects time series of skill demand 315 for the skills in the key skill cluster.

In step 404, the process uses this data to build input data for a prediction process. For example, the input data can be placed into an input table. Each column in this input table can be for a skill in the key skill cluster for a specified in a specific month. For example, the key skill is Python and the skills inside of the key skill cluster for this key skill are C, C++, JAVA, and COBOL. Each of these skills can be represented as a column for a specific month. The rows in this table are the skill shares corresponding to the skills for specific month and the columns. This input data forms training dataset 409.

In this example, the process trains a model using the training dataset 409 (step 404). In step 404, the model is multivariate time series prediction model 411. The process predicts skill demand for the key skill for number of months ahead 407 using time series prediction model 411 (step 408). In step 408, the prediction includes a prediction for all skills and the key skill cluster in addition to the key skill to form skill cluster prediction 413. In this example, the skill cluster prediction is a predicted skill share for each of the skills in the skill cluster for number of months ahead 407. Time series prediction model 411 can be a multivariate time series prediction model.

In this example, step 404, step 406, in step 408 can be performed for each skill cluster in the skill clusters 405 identified using the skills for the user. The result of the steps are skill share predictions for the different skills in skill clusters 405. In some illustrative examples, skill cluster prediction 413 will include skill shares for key skills from each of the clusters. In other words, the skill shares predicted for other skills may be omitted from skill cluster prediction 413.

The process then predicts a skill score of the relevance of the user skills for number of months ahead 407 (step 410). In step 410, the skill score is based on a current skill demand and a skill demand change. As depicted, the current skill demand can be determined as follows:

$$score = {\sum }_{s = 1}^{n} {cv}_{s} \qquad ( 2 )$$

where score is a sum of the skills shares for a user, s is a skill index of skills for the user, n is the number of skills, cvₛ is a current skill share for skill s. In this example, the skill demand change is determined as follows:

$$gain = {\sum }_{s = 1}^{n} \frac{{pv}_{s} - {cv}_{s}}{time} \qquad ( 3 )$$

where gain is a change in a value for the skills for the user, s is the skill index, n is the number of skills, pvₛ is the predicted skill share for the skill s, cvₛ is the current skill share for the skill s, time is the number of months ahead to be predicted.

In this illustrative example, the skills score is used to return a report of trends 415 to user 403. In this example, report of trends 415 in this example, the skill score can be determined for each skill submitted by user 403 for analysis. In this illustrative example, the skills are skills in a skill set for the user. In other illustrative examples, the user may input a skill that the user is considering acquiring or learning.

Further, when skill cluster prediction 413 includes other skills in addition to the key skills, the other skills can be analyzed to determine whether those skills would be useful to user 403. In this example, suggestions of additional skills can be recommended to user 403 based on how related those skills are to the key skills possessed by the user 403. In this example, these other skills are considered related because they are clustered within the same cluster as the key skill.

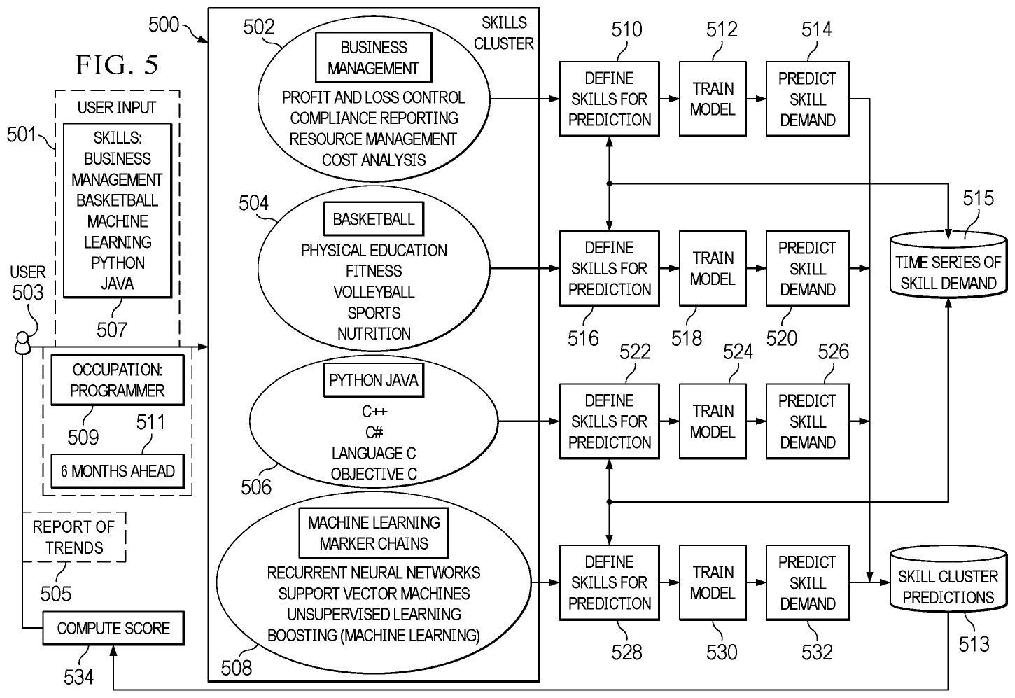

In FIG. 5, a data flow diagram illustrating an example use case for generating a report of trends for user is depicted in accordance with an illustrative embodiment. This dataflow can be implemented in skill demand forecasts are 214 in FIG. 2.

As depicted, user 501 generates user input 503 for use in obtaining report of trends 505. As depicted, user input 503 includes skills 507, occupation 509, and future time 511. In this example, skills 507 comprise business management, basketball, machine learning, Python, and java. In this example, future time 511 is 6 months ahead.

As depicted, business management is in skill cluster 502. Other skills in this skill cluster include profit and loss control, compliance reporting, resource management, and cost analysis. Basketball is in skill cluster 504. The skill cluster also includes physical education, fitness, volleyball, sports, and nutrition.

In this illustrative example, the skills Python and Java are in skill cluster 506. This skill cluster also includes C++, C#, Language C, and Objective C. The skill machine learning is in skill cluster 508. This skill cluster also includes Markov chains, recurrent neural networks, support vector machines, unsupervised learning, and boosting (machine learning).

This illustrative example, each of these clusters is processed to generate machine learning models that predict skill cluster predictions 513. As depicted, for skill cluster 502, the process defines skills for prediction (step 510) using the skills identified in skill cluster 502 to collect time series of skill demand 515 for the skills in skill cluster 502. This data is used to generate a training data set that is used to train a multivariate time series prediction model (step 512). This trained model is used to generate a skill cluster prediction for skill cluster predictions 513 (step 514).

For skill cluster 504, the process defines skills for prediction (step 516) using the skills identified in skill cluster 504 to collect time series of skill demand 515 for the skills in skill cluster 504. This data is used to generate a training data set that is used to train a multivariate time series prediction model (step 518). This trained model is used to generate a skill cluster prediction for skill cluster predictions 513 (step 520).

The process also defines skills for prediction (step 522) using the skills identified in skill cluster 506 to collect time series of skill demand 515 for the skills in skill cluster 506. The collected data is used to generate a training data set that is used to train a multivariate time series prediction model (step 524). After training, this model is used to generate a skill cluster prediction for skill cluster predictions 513 (step 526).

As depicted, for skill cluster 508, the process defines skills for prediction (step 528) using the skills identified in skill cluster 508 to collect time series of skill demand 515 for the skills in skill cluster 508. This collected data is used to generate a training data set that is used to train a multivariate time series prediction model (step 530). This trained model is used to generate a skill cluster prediction for skill cluster predictions 513 (step 532).

The different steps performed for the different clusters result in the creation of a multivariate time series prediction model for each of the clusters. In the illustrative examples, the cluster generation and training of the machine learning model does not need to be performed each time the request is received to analyze skills in a skill set. In future requests for skill analysis, skill cluster predictions 513 for these clusters can be used without needing to create a training dataset and train the machine learning model. With this example, the multivariate time series prediction models can be re-created or updated periodically to ensure that the multivariate time series prediction models operate using current data about job advertisements and employment.

In this illustrative example, the process computes a score using skill cluster predictions 513 (step 534). The score is used to create and return report of trends 505 to user 501. As a result, user 501 can obtain a personalized analysis of the future skill demand for skills in the skill set of user 501. With this information, user 501 can make decisions regarding careers and skills. For example, user 501 can decide whether to increase the expertise in one or more skills.

Further, when other skills are included in report of trends 505 in addition to the skills and the skill set for user 501, user 501 can also evaluate those additional skills to determine whether to add those skills to the skill set of user 501. For example, the process can identify related skills from the different skill clusters that have a skill demand that increases above a threshold used to select skills for consideration. These skills can be presented to user 501 and report of trends 505. For example, support vector machines in skill cluster 508 can have an increase in skill demand that exceeds a threshold in 6 months ahead. As a result, this skill can be included in report of trends 505 as a related skill to machine learning for user 501 for consideration by the user 501.

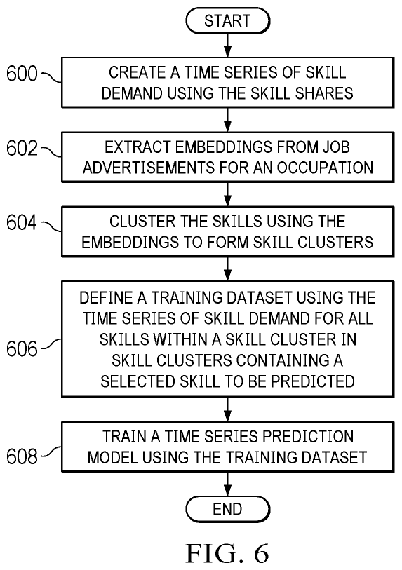

Turning next to FIG. 6, a flowchart of a process for analyzing skills is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in skill demand forecaster 214 in computer system 212 in FIG. 2.

The process begins by creating a time series of skill demand using the skill shares (step 600). The process extracts embeddings from job advertisements for an occupation (step 602). The process clusters the skills using the embeddings to form skill clusters (step 604).

The process defines a training dataset using the time series of skill demand for all skills within a skill cluster in skill clusters containing a selected skill to be predicted (step 606). The process trains a time series prediction model using the training dataset (step 608). The process terminates thereafter.

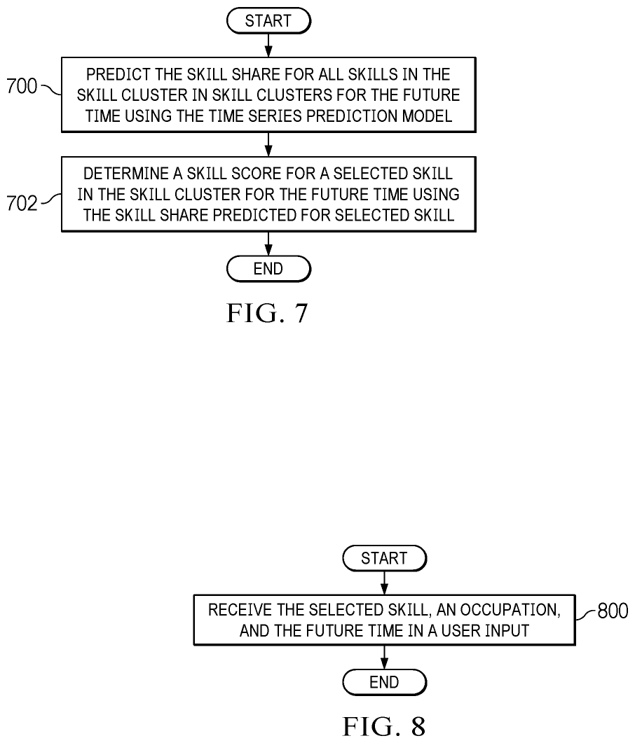

With reference now to FIG. 7, a flowchart of a process for determining a skill demand is depicted in accordance with an illustrative embodiment. The process illustrated in FIG. 7 is an example of steps that can be performed in addition to the steps in FIG. 6.

The process predicts the skill share for all skills in the skill cluster in skill clusters for the future time using the time series prediction model (step 700). The process determines a skill score for a selected skill in the skill cluster for the future time using the skill share predicted for selected skill (step 702). The process terminates thereafter. Skill score in step 702 indicates a demand for the skill of interest at the future time.

Turning to FIG. 8, a flowchart of process for receiving user input is depicted in accordance with an illustrative embodiment. The process illustrated in FIG. 8 is an example of the steps that can be performed with the steps in FIG. 7.

In this example, the process receives the selected skill, an occupation, and the future time in a user input (step 800). The process terminates thereafter.

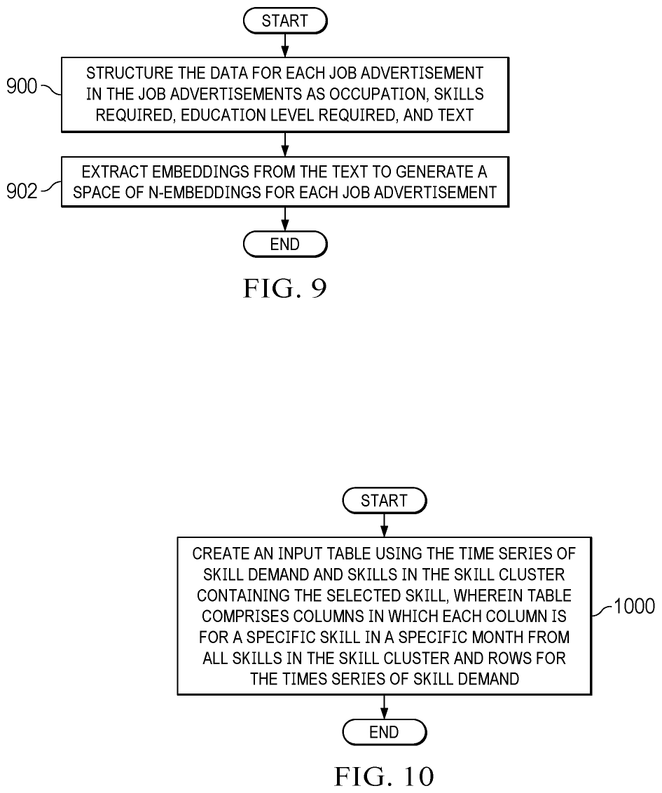

In FIG. 9, a flowchart of a process for creating embeddings is depicted in accordance with an illustrative embodiment. The process illustrated in FIG. 9 is an example of steps that can be used with the steps in FIG. 5.

The process structures the data for each job advertisement in the job advertisements as occupation, skills required, education level required, and text (step 900). The process extracts embeddings from the text to generate a space of n-embeddings for each job advertisement (step 902). The process terminates thereafter.

Turning now to FIG. 10, a flowchart of a process for creating a training data set is depicted in accordance with an illustrative embodiment. The process illustrated in FIG. 9 is an example of an implementation for step 606 in FIG. 6.

The process creates an input table using the time series of skill demand and skills in the skill cluster containing the selected skill, wherein table comprises columns in which each column is for a specific skill in a specific month from all skills in the skill cluster and rows for the times series of skill demand (step 1000). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

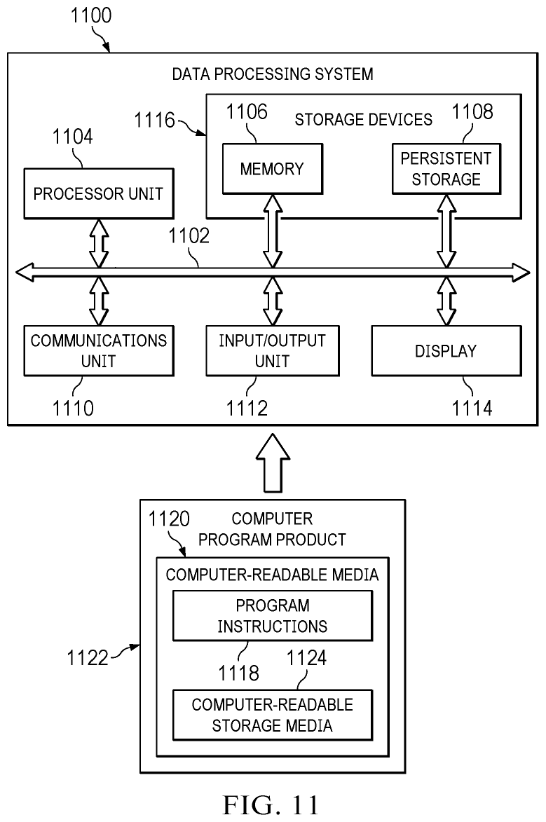

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 212 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer readable program instructions that can be read and executed by a processor in processor unit 1104. The program instructions in the different embodiments can be embodied on different physical or computer readable storage media, such as memory 1106 or persistent storage 1108.

Program instructions 1118 are located in a functional form on computer readable media 1120 that is selectively removable and can be loaded onto or transferred to data processing system 1100 for execution by processor unit 1104. Program instructions 1118 and computer readable media 1120 form computer program product 1122 in these illustrative examples. In the illustrative example, computer readable media 1120 is computer readable storage media 1124.

Computer readable storage media 1124 is a physical or tangible storage device used to store program instructions 1118 rather than a medium that propagates or transmits program instructions 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer readable signal media. The computer readable signal media are signals and can be, for example, a propagated data signal containing program instructions 1118. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1120” can be singular or plural. For example, program instructions 1118 can be located in computer readable media 1120 in the form of a single storage device or system. In another example, program instructions 1118 can be located in computer readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer readable media 1120 in a server computer while another portion of program instructions 1118 can be located in computer readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of, another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments of the present invention provide a computer implemented method, computer system, and computer program product for forecasting a future skill demand. A number of processor units determines skill shares for skills from job advertisements. A skill share for a skill identifies a number of times a skill has appeared in job advertisements during a given period of time. The number of processor units creates a time series of skill demand using the skill shares. The computer implemented method extracts embeddings from job advertisements for an occupation using natural language processing. The number of processor units clusters the skills using the embeddings to form skill clusters. The number of processor units defines a training dataset using a time series of skill demand for all skills within a cluster containing a selected skill to be predicted. The number of processor units trains a time series prediction model using the training dataset. According to other illustrative embodiments, a computer system and a computer program product for predicting skill demand are provided.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
determining, by a number of processor units, skill shares for skills from job advertisements, wherein a skill share for a skill identifies a number of times the skill has appeared in job advertisements during a given period of time;
creating, by the number of processor units, a time series of skill demand using the skill shares;
extracting, by the number of processor units, embeddings from job advertisements for an occupation;
clustering, by the number of processor units, the skills using the embeddings to form skill clusters;
defining, by the number of processor units, a training dataset using the time series of skill demand for all skills within a skill cluster in skill clusters containing a selected skill to be predicted; and
training, by the number of processor units, a time series prediction model using the training dataset.

2. The computer implemented method of claim 1, wherein the training dataset is for a future time and further comprising:
predicting, by the number of processor units, the skill share for all skills in the skill cluster in skill clusters for the future time using the time series prediction model; and
determining, by the number of processor units, a skill score for a selected skill in the skill cluster for the future time using the skill share predicted for selected skill.

3. The computer implemented method of claim 2 further comprising:
receiving, by the number of processor units, the selected skill, the occupation, and the future time in a user input.

4. The computer implemented method of claim 1 further comprising:
structuring, by the number of processor units, data for each job advertisement in the job advertisements as occupation, skills required, education level required, and text; and
extracting, by the number of processor units, embeddings from the text to generate a space of n-embeddings for each job advertisement.

5. The computer implemented method of claim 1, wherein defining, by the number of processor units, the training dataset comprises:
creating, by the number of processor units, an input table using the time series of skill demand and skills in the skill cluster containing the selected skill, wherein table comprises columns in which each column is for a specific skill in a specific month from all skills in the skill cluster and rows for the times series of skill demand.

6. The computer implemented method of claim 1, wherein the skill share is determined as is as follows:
$$skill {share}_{i , j , t} = \frac{{ads}_{i , j , t}}{all {ads}_{j , t}} \times \frac{{emp}_{j , t}}{all {emp}_{t}}$$
where i is a skill, j is an occupation, and t is a month, ads_{i,j,t} is the number of advertisements for skill i in occupation j in month t, and all ads_{j,t} is the number of advertisements for occupation j in month t, emp_{j,t} is employment for occupation j in month t, and all, emp_{,t} is employment for all occupations in month t.

7. The computer implemented method of claim 2 further comprising:
determining a skill score based on a current skill demand and a skill demand change.

8. The computer implemented method of claim 7, wherein the current skill demand is determined as follows:
$$score = {\sum }_{s = 1}^{n} {cv}_{s}$$
where score is a sum of the skills shares for a user, s is a skill index of skills for the user, n is the number of skills, cvₛ is a current skill share for skill s; and
wherein the skill demand change is determined as follows:
$$gain = {\sum }_{s = 1}^{n} \frac{{pv}_{s} - {cv}_{s}}{time}$$
where gain is a change in a value for the skills for the user, s is the skill index, n is the number of skills, pvₛ is the predicted skill share for the skill s, cvₛ is the current skill share for the skill s, time is the number of months.

9. A computer system comprising:
a number of processor units, wherein the number of processor units executes program instructions to:
determine skill shares for skills from job advertisements, wherein a skill share for a skill identifies a number of times the skill has appeared in job advertisements during a given period of time;
create a time series of skill demand using the skill shares;
extract embeddings from job advertisements for an occupation;
cluster the skills using the embeddings to form skill clusters;
define a training dataset using the time series of skill demand for all skills within a skill cluster in skill clusters containing a selected skill to be predicted; and
train a time series prediction model using the training dataset.

10. The computer system of claim 9, wherein the training dataset is for a future time and wherein the number of processor units executes program instructions to:
predict the skill share for all skills in the skill cluster in skill clusters for the future time using the time series prediction model; and
determine a skill score for a selected skill in the skill cluster for the future time using the skill share predicted for selected skill.

11. The computer system of claim 10, wherein the number of processor units executes program instructions to: further comprising:
receive the selected skill, the occupation, and the future time in a user input.

12. The computer system of claim 9, wherein the number of processor units executes program instructions to:
structure data for each job advertisement in the job advertisements as occupation, skills required, education level required, and text; and
extract embeddings from the text to generate a space of n-embeddings for each job advertisement.

13. The computer system of claim 9, wherein in defining the training dataset, the number of processor units executes program instructions to:
create an input table using the time series of skill demand and skills in the skill cluster containing the selected skill, wherein the table comprises columns in which each column is for a specific skill in a specific month from all skills in the skill cluster and rows for the times series of skill demand.

14. The computer system of claim 9, wherein the skill share is determined as is as follows:
$$skill {share}_{i , j , t} = \frac{{ads}_{i , j , t}}{all {ads}_{j , t}} \times \frac{{emp}_{j , t}}{all {emp}_{t}}$$
where i is a skill, j is an occupation, and t is a month, ads_{i,j,t} is the number of advertisements for skill i in occupation j in month t, and all ads_{j,t} is the number of advertisements for occupation j in month t, emp_{j,t} is employment for occupation j in month t, and all, emp_{,t} is employment for all occupations in month t.

15. The computer system of claim 10, wherein the number of processor units executes program instructions to:
determine a skill score based on a current skill demand and a skill demand change.

16. The computer system of claim 15, wherein the current skill demand is determined as follows:
$$score = {\sum }_{s = 1}^{n} {cv}_{s}$$
where score is a sum of the skills shares for a user, s is a skill index of skills for the user, n is the number of skills, cvₛ is a current skill share for skill s; and
wherein the skill demand change is determined as follows:
$$gain = {\sum }_{s = 1}^{n} \frac{{pv}_{s} - {cv}_{s}}{time}$$
where gain is a change in a value for the skills for the user, s is the skill index, n is the number of skills, pvₛ is the predicted skill share for the skill s, cvₛ is the current skill share for the skill s, time is the number of months.

17. A computer program product comprising a computer readable storage medium having program instructions embodied therewith, the program instructions executable by a computer system to cause the computer system to perform a method of:
determining skill shares for skills from job advertisements, wherein a skill share for a skill identifies a number of times the skill has appeared in job advertisements during a given period of time;
creating a time series of skill demand using the skill shares;
extracting embeddings from job advertisements for an occupation;
clustering the skills using the embeddings to form skill clusters;
defining a training dataset using the time series of skill demand for all skills within a skill cluster in skill clusters containing a selected skill to be predicted; and
training a time series prediction model using the training dataset.

18. The computer program product of claim 17, wherein the training dataset is for a future time and further comprising:
predicting the skill share for all skills in the skill cluster in skill clusters for the future time using the time series prediction model; and
determine a skill score for a selected skill in the skill cluster for the future time using the skill share predicted for selected skill.

19. The computer program product of claim 18 further comprising:
receiving the selected skill, an occupation, and the future time in a user input.

20. The computer program product of claim 17 further comprising:
structuring data for each job advertisement in the job advertisements as occupation, skills required, education level required, and text; and
extracting embeddings from the text to generate a space of n-embeddings for each job advertisement.
